(19) United States
(12) Patent Application Publication
(10) Pub. No.: US 2007/0225409 A1
(43) Pub. Date: Sep. 27, 2007

(54) Method for Production Thermoplastic Resin Composition Containing Ultrafine Particles

(76) Inventor: Kazuaki Matsumoto, Osaka (JP)

Correspondence Address: BRINKS HOFER GILSON & LIONE, P.O. BOX 10395, CHICAGO, IL, 60610, US

(21) Appl. No.: 10/591,075

(22) PCT Filed: Feb. 23, 2005
(86) PCT No.: PCT/JP05/02850

§ 371 Date: May 21, 2007

(30) Foreign Application Priority Data
Mar. 3, 2004 (JP) 2004-059866

(51) Int. Cl. C08L 101/00

(52) U.S. Cl. 524/81

(57) ABSTRACT

A method for producing a thermoplastic resin composition containing ultrafine particles on an industrial scale is provided. The method for producing the thermoplastic resin composition containing ultrafine particles includes mixing a metal-containing organic compound with a thermoplastic resin; and then heating the resulting mixture at a temperature of not lower than the decomposition starting temperature and lower than the complete decomposition temperature of the metal-containing organic compound to produce a composition containing ultrafine metal particles and/or ultrafine metal oxide particles having a number-average particle size of 0.1 to 80 nm dispersed in the thermoplastic resin.

### TECHNICAL FIELD

The present invention relates to a method for producing a thermoplastic resin composition containing ultrafine particles. In particular, the present invention relates to a method for easily producing a resin component containing ultrafine particles dispersed in a thermoplastic resin on an industrial scale.

### BACKGROUND ART

Ultrafine particles each having a particle size of several tens of nanometers or less are significantly different in characteristics from general particles. For example, gold (Au) particles with a particle size of 10 nm or less have characteristics, for example, a significantly decreased melting point. Furthermore, such ultrafine particles have, for example, a high catalytic activity and thus have new possibilities in various fields in the future. In particular, ultrafine metal particles are believed to be applied to, for example, a paste having low-temperature sinterability, the paste being used as a wiring material for electronics. Furthermore, ultrafine metal oxide particles are expected to be applied to various industrial materials, such as fluorescent materials and semiconductor materials, for use in optical applications and the like.

A process of evaporating a material metal under reduced pressure in the presence of a small quantity of gas to form ultrafine metal particles is proposed as a process for producing such ultrafine particles from a gas phase(for example, see Patent Document 1). Furthermore, a process of preparing ultrafine particles from a liquid phase is also proposed (for example, see Non-Patent Document 1). However, the strong aggregation of the ultrafine particles obtained by the liquid phase process results in difficulty in stably storing the particles for a prolonged period. Furthermore, in the process of preparing the ultrafine particles from the liquid phase, high-temperature treatment is difficult to be performed in producing the ultrafine particles; hence, the resulting ultrafine particles generally contain a relatively large amount of impurities, such as organic residues, thereby leading to insufficient purity for use in electronic materials and the like.

Furthermore, in these processes, to prevent the aggregation of the particles, it is necessary to use a surface modifier, such as a surfactant, for achieving stable dispersion to form protective colloids almost exclusively. However, there is still room for improvement from the standpoint of dispersion stability.

A process of heating decomposition a metal-containing organic compound in a predetermined atmosphere to produce ultrafine particles is disclosed as a process for producing ultrafine particles with satisfactory dispersion stability on an industrial scale (for example, see Patent Document 2). This process is useful as a process for easily producing ultrafine metal particles at low cost. However, when ultrafine particles produced by this process are dispersed in a thermoplastic resin to produce an ultrafine particle-containing thermoplastic resin composition, in a generally known production process such as melt-kneading, the ultrafine particles aggregate in the melted resin. Thus, it is difficult to disperse the ultrafine particles in the resin without aggregation.

As a process of dispersing ultrafine particles in a thermoplastic resin, a process of dispersing ultrafine particles in a resin using the combination of ultrafine metal oxide particles having organically modified surfaces and a functional group-containing thermoplastic resin is disclosed (for example, see Patent Document 3 and Non-Patent Document 2).

Furthermore, the following special production processes are known as other processes: for example, a process of synthesizing particles in the presence of a resin; a process of initiating polymerization from the surfaces of particles in the presence of particles; and a process of forming coordinate bonds between a polymer and the surfaces of ultrafine particles (for example, see Non-Patent Documents 3 to 7).
Patent Document 1: Japanese Unexamined Patent Application Publication No. 60-78635
Patent Document 2: Japanese Unexamined Patent Application Publication No. 10-183207
Patent Document 3: Japanese Unexamined Patent Application Publication No. 2003-313379
Non-Patent Document 1: S. Huang et al., J. Vac. Sci. Technol., B 19, 2045(2001)
Non-Patent Document 2: K. Matsumoto et al., J. Soc. Powder Technol. Jpn., 41(7), 489(2003)
Non-Patent Document 3: S. Ogawa et al., Jpn. J. Appl. Phys., 33, L331(1994)
Non-Patent Document 4: Q. Song et al., J. Nanoparticle. Res., 2, 381(2000)
Non-Patent Document 5: T. K. Mandal et al., Nano Lett., 2, 3(2002)
Non-Patent Document 6: S. Hirano et al., J. Eur. Ceram. Soc., 21, 1479(2001)
Non-Patent Document 7: K. Matsumoto et al., Chem. Lett., 33, 1256(2004)

### DISCLOSURE OF INVENTION

Problems to be Solved by the Invention

It is an object of the present invention to provide a method for easily producing a resin composition on an industrial scale, the resin composition having ultrafine metal particles and/or ultrafine metal oxide particles satisfactorily dispersed in a resin.

Means for Solving the Problems

In consideration of the problems of the above-described known art, the inventor has conducted intensive studies and found that an epoch-making process of synthesizing ultrafine particles in a resin, modifying the surface of the ultrafine particles, and dispersing the resulting ultrafine particles in the resin, the modification and the dispersion being achieved simultaneously with the synthesis, and the process significantly easily achieving industrialization and continuous mass production. This finding resulted in completion of the present invention.

The present invention relates to a method for producing a thermoplastic resin composition containing ultrafine particles, the method including mixing a metal-containing organic compound with a thermoplastic resin; and then heating the resulting mixture at a temperature of not lower than the decomposition starting temperature and lower than the complete decomposition temperature of the metal-containing organic compound to produce a composition containing ultrafine metal particles and/or ultrafine metal oxide particles having a number-average particle size of 0.1 to 80 nm dispersed in the thermoplastic resin.

A preferred embodiment relates to the method for producing the thermoplastic resin composition containing ultrafine particles, wherein the ultrafine metal particles and/or the ultrafine metal oxide particles having a number-average particle size of 0.1 to 80 nm dispersed in the thermoplastic resin is composed of a metal component or a metal oxide component, and an organic component is bonded to the surface of each particle.

A preferred embodiment relates to the method for producing the thermoplastic resin composition containing ultrafine particles, wherein the ultrafine particles having a number-average particle size of 0.1 to 80 nm dispersed in the thermoplastic resin are synthesized in the thermoplastic resin.

A preferred embodiment relates to the method for producing the thermoplastic resin composition containing ultrafine particles, wherein the heating temperature is not lower than the decomposition starting temperature of the metal-containing organic compound, lower than the complete decomposition temperature of the metal-containing organic compound, and higher than the melting point of the thermoplastic resin.

A preferred embodiment relates to the method for producing the thermoplastic resin composition containing ultrafine particles, wherein the metal component is at least one element selected from Cu, Ag, Au, Zn, Cd, Ga, In, Si, Ge, Ti, Sn, Pd, Fe, Co, Ni, Ru, Rh, Os, Ir, Pt, V, Cr, Mn, Y, Zr, Nb, Mo, Ca, Sr, Ba, Sb, and Bi.

A preferred embodiment relates to the method for producing the thermoplastic resin composition containing ultrafine particles, including the steps of heating the metal-containing organic compound at a temperature of not lower than the decomposition starting temperature of the metal-containing organic compound, lower than the complete decomposition temperature of the metal-containing organic compound, and higher than the melting point of the thermoplastic resin, and then reducing the resulting melted thermoplastic resin composition at a pressure equal to or lower than atmospheric pressure.

A preferred embodiment relates to the method for producing the thermoplastic resin composition containing ultrafine particles, the method further including kneading the melted thermoplastic resin and the metal-containing organic compound to disperse ultrafine metal particles and/or ultrafine metal oxide particles in the thermoplastic resin, wherein the central portion of each particle is composed of a metal component or a metal oxide component, an organic component is bonded to the surface of each particle, and the particles dispersed have a number-average particle size of 1 to 60 nm.

### EFFECTS OF THE INVENTION

According to the production process of the present invention, a large amount of a thermoplastic resin composition containing ultrafine particles satisfactorily dispersed in a resin can be produced easily and continuously. This opens a new path to the industrialization of an ultrafine particles-containing resin composition.

The resulting resin composition can be widely used as a resin film for various applications. Examples of the applications include electronic materials, such as printed wiring and conductive materials; magnetic materials, such as magnetic recording media, electromagnetic-wave absorbers, and electromagnetic-wave resonators; catalytic materials, such as high-reaction-rate catalysts and sensors; structural materials, such as far-infrared materials and composite-film-forming materials; optical materials, such as specific-wavelength-light-shielding filter, heat-ray-absorbing materials, ultraviolet-ray-shielding materials, wavelength conversion materials, polarizing materials, highly refractive materials, antiglare materials, and luminescent elements; ceramics and metal materials, such as sintering agents and coating materials; and medical materials, such as antimicrobial materials and permeable membranes.

Since the ultrafine particles are dispersed in the resin, the ultrafine particles can be stably stored in a dispersion state on a semipermanent basis. Furthermore, the ultrafine particles can be easily taken out by melting the resin or burning out the resin when needed. Thus, the method also advantageously has the effect of significantly facilitating the handling, such as production, sale, storage, and transport, of the ultrafine particles.

### BRIEF DESCRIPTION OF THE DRAWINGS

FIG. 1 is a transmission electron micrograph of a resin composition obtained in EXAMPLE 1.

[image]

### BEST MODE FOR CARRYING OUT THE INVENTION

The present invention will be described below with Embodiments.

In the present invention, a metal-containing organic compound refers to an organic compound containing a metal element. Examples thereof include organometallic compounds, metal alkoxides, and metal salts of carbanions. The metal-containing organic compound is not particularly limited. Any one of commercially available products and synthetic products can be used. Examples thereof include metal salts of saturated or unsaturated, linear or branched aliphatic carboxylic acids each having a carbon atom number of 2 (hereinafter, abbreviated as “C2”) to 100; metal salts of saturated or unsaturated alicyclic carboxylic acids each having C3 to C100; metal salts of aromatic carboxylic acids each having C6 to C100; metal salts of saturated or unsaturated, linear or branched aliphatic sulfonic acids each having C2 to C100; metal salts of saturated or unsaturated alicyclic sulfonic acids each having C3 to C100; metal salts of aromatic sulfonic acids each having C6 to C100; metal alkoxides each having C1 to C50; and metal complexes each having C1 to C10. Specific examples thereof include metal salts of carboxylic acids, such as naphthenates, octanoates, laurates, oleates, stearates, benzoates, and para-toluates; metal alkoxides, such as n-butoxides, tert-butoxides, n-propoxides, i-propoxides, ethoxides, and methoxides; and metal acetylacetonates. Among them, in particular, laurates, oleates, stearates, paratoluates, metal ethoxides, metal propoxides, metal acetylacetonates, and the like are preferred. Among the metal salts of the aliphatic acids, in view of ease of the progress of reaction, linear aliphatic acids are preferred. The number of carbon atoms is preferably 6 to 30 and more preferably 8 to 20.

However, a preferred metal-containing organic compound is generally determined in response to the combination of the organic compound and a resin. According to the kind of selected resin, a preferred metal-containing organic compound needs to be appropriately changed. To increase the dispersibility of the ultrafine particles in the resin composition, a metal-containing organic compound having a polarity close to the resin or a metal-containing organic compound containing an organic group having satisfactory compatibility with the resin is preferably used. Furthermore, preferably, the combination of the resin and the metal-containing organic compound is selected such that the resin melts and is not thermally decomposed at a temperature of not lower than the decomposition starting temperature and lower than the complete decomposition temperature of the metal-containing organic compound.

In the metal-containing organic compound, a functional group or a moiety of a modified compound may be used as an organic group in order to control compatibility with a resin to be used and to control the thermal decomposition temperature. Preferred examples of the functional group include a hydroxyl group, a carbonyl group, and an amino group. Preferred examples of the modified compound include perfluoro compounds.

The metal-containing organic compound may be used alone or, two or more metal-containing organic compounds in combination. The metal in the metal-containing organic compound is not particularly limited but may be appropriately selected according to, for example, the application of a final article. Furthermore, in the method of the present invention, for example, ultrafine alloy particles can be prepared by mixing a metal-containing organic compound having two or more of metals in advance. The shape of the metal-containing organic compound as a starting material is not particularly limited. The metal-containing organic compound may have any one of the shapes, such as a powder, a liquid, flakes, and pellets.

A metal component is not particularly limited as long as the metal component is derived from the metal-containing organic compound. Preferably, the metal component is at least one element selected from Cu, Ag, Au, Zn, Cd, Ga, In, Si, Ge, Ti, Sn, Pd, Fe, Co, Ni, Ru, Rh, Os, Ir, Pt, V, Cr, Mn, Y, Zr, Nb, Mo, Ca, Sr, Ba, Sb, and Bi. More preferably, the metal component is at least one element selected from Cu, Ag, Au, Zn, Cd, Ga, In, Si, Ge, Ti, Sn, Pd, Fe, Co, Ni, Ru, Rh, Os, Ir, Pt, V, Cr, Mn, Y, Nb, and Mo. The metal component of the present invention include every possible state of these metals, i.e., the metal component may be one selected from these elements, a mixture of these metals, an alloy of these metals, or the like.

The content of the metal component in each of the ultrafine particles of the present invention may be appropriately set in response to, for example, the application of the final article. Usually, the content of the metal component needs to be set to about 40 to 90 percent by weight.

The ultrafine particles produced in the present invention are ultrafine metal particles and/or ultrafine metal oxide particles having a number-average particle size of 0.1 to 80 nm. The ultrafine particles may be a mixture of the ultrafine metal particles and the ultrafine metal oxide particles. The ultrafine particles may contain a metal portion and a metal oxide portion. Furthermore, in some cases, each of the ultrafine particles has a structure in which a region near the center of each ultrafine particle is mainly composed of a metal and a region near the surface of each ultrafine particle is mainly composed of a metal oxide.

It is preferred that each ultrafine particle is composed of a metal component and/or a metal oxide component, a component derived from the metal-containing organic compound is bonded to the surface of each ultrafine particle, and an organic component is bonded to the surface. The bonding of the organic component to the surface of each ultrafine particle results in a resin composition having the high dispersibility of the ultrafine particles in the resin. The organic component is partially or completely, chemically or tonically bonded to the metal component. Furthermore, the present invention includes the case where the metal portion or the metal oxide portion of each ultrafine particle has the metal-containing organic compound, the organic component derived from the metal-containing organic compound, or the like.

To determine whether the organic compound is bonded to the surface of each ultrafine particle or not, the following method is employed: An ultrafine particle-containing resin composition is dissolved in an organic solvent that dissolves the resin and that is immiscible with water in any ratio. After deionized water is added to the organic solvent, the resulting mixture is stirred. The determination can be achieved depending on whether the ultrafine particles are present in an organic solvent layer or an aqueous layer. That is, when the organic compound is bonded to the surfaces of the ultrafine particles, the ultrafine particles are extracted in the organic solvent layer. When the organic compound is not bonded to the surfaces of the ultrafine particles, the ultrafine particles are extracted in the aqueous layer.

The dispersed ultrafine particles of the present invention have a number-average particle size of 0.1 to 80 nm. When the ultrafine particles are produced by a preferred production process, for example, by kneading with a melted resin, the number-average particle size is generally 1 to 60 nm, preferably 1.2 to 50 nm, and more preferably 1.5 to 45 nm.

The term “number-average particle size” in the present invention means a number-average particle size determined by measuring the particle sizes of at least 100 particles in a transmission electron micrograph or a scanning electron micrograph with a ruler and then calculating a number-average particle size. In the case where each particle in the electron microgram does not have a circular shape, after the area occupied by the particle is calculated, the diameter of a circle having the same area as that occupied by the particle can be used. Furthermore, in a transparent film or a formed article, it is possible, for some metals such as gold and silver, to estimate the degree of dispersion by measuring the dependence of transmittance on wavelength.

The shape of each of the ultrafine particles usable in the present invention is not particularly limited. Each ultrafine particle may have any shape. Specific examples of the shape include a spherical shape, a rugby ball shape, a soccer ball shape, a near-spherical shape such as an icosahedron, a hexahedron shape, a rod shape, a needle shape, a flat shape, a scale shape, a fractured shape, and an indefinite shape. Furthermore, each ultrafine particle may have a cavity or a defect in the surface thereof or therein. Alternatively, the ultrafine particles may be porous particles each having many holes at the surface thereof or therein. However, when the ultrafine particles are produced by the production process of the present invention, usually, each of the ultrafine particles often has a spherical shape or a near-spherical shape.

The ultrafine particles of the present invention are synthesized in the mixture of a thermoplastic resin and the metal-containing organic compound. Synthesis of the ultrafine particles in the presence of the thermoplastic resin can prevent the aggregation and fusion of the ultrafine particles in the formation of the ultrafine particles. Thus, the ultrafine particles with a controlled particle size can be easily synthesized. Furthermore, it is possible to disperse the ultrafine particles in the resin simultaneously with the synthesis of the ultrafine particles, thereby to produce a resin composition significantly easily.

As a method for synthesizing the ultrafine particles by mixing the metal-containing organic compound and the thermoplastic resin, the following methods are exemplified: a method of dispersing or dissolving the metal-containing organic compound and the resin in a solvent, heating the resulting mixture, and removing the solvent; a method for synthesizing the ultrafine particles in the melted resin by mixing the metal-containing organic compound with the thermoplastic resin while the thermoplastic resin is heated at a temperature equal to or higher than the melting point of the resin; and a method for synthesizing the ultrafine particles in the melted resin by mixing the thermoplastic resin with the metal-containing organic compound in advance, and heating the mixture at a temperature equal to or higher than the melting point of the resin.

The ultrafine particles dispersed in the thermoplastic resin are preferably synthesized in the thermoplastic resin. This is because it is expected that the thermoplastic resin functions to prevent the aggregation of the ultrafine particles by synthesizing the ultrafine particles in the thermoplastic resin.

Among these methods for synthesizing the ultrafine particles by mixing the metal-containing organic compound with the thermoplastic resin, it is preferred to employ the method of heating the metal-containing organic compound at a temperature of not lower than the decomposition starting temperature and lower than the complete decomposition temperature of the metal-containing organic compound in the presence of the thermoplastic resin to produce the ultrafine particles. The thermoplastic resin composition containing the ultrafine particles appropriately dispersed in the thermoplastic resin can be easily produced by the method.

For example, when a metal-containing organic compound having characteristics, such as sublimation and rapid decomposition, is used as a starting material, the metal-containing organic compound can be effectively used by mixing in a preliminary melted resin in order to control sublimation and reactivity.

The heating temperature is not particularly limited unless the metal-containing organic compound is completely decomposed. At a heating temperature of not lower than the decomposition starting temperature and lower than the complete decomposition temperature of the metal-containing organic compound, it is possible to synthesize the ultrafine particles having a controlled particle size and a controlled composition. The term “decomposition starting temperature” means a temperature at which the organic moiety of the metal-containing organic compound is detached from the metal moiety or at which the organic moiety begins to decompose. The term “complete decomposition temperature” means a temperature at which the organic moiety of the metal-containing organic compound is substantially completely detached from the metal moiety or at which the organic moiety is completely decomposed. In the case of a general compound other than a compound having sublimation or volatility, this temperature can be determined by the following method or the like: after a small amount of the metal-containing organic compound is weighed and placed in a vessel, a change in weight is measured with increasing temperature at a predetermined heating rate in an inert gas atmosphere using a thermogravimetric analyzer.

For example, the rate of heating weight loss of the metal-containing organic compound of the present invention is measured in a nitrogen atmosphere while the temperature increases. The decomposition starting temperature is defined as a temperature at which the weight loss begins. The complete decomposition temperature is defined as a temperature at which no further weight loss is observed. When the rate of weight loss is measured in an inert gas atmosphere by the same method while the temperature increases at a constant heating rate of 10° C./min, a more preferred heating temperature is at least a temperature at which the rate of weight loss reaches 5% of the organic moiety of the metal-containing organic compound and not more than a temperature at which the rate of weight loss reaches 95% of the organic moiety of the metal-containing organic compound, still more preferably at least a temperature at which the rate of weight loss reaches 10% of the organic moiety of the metal-containing organic compound and not more than a temperature at which the rate of weight loss reaches 90% of the organic moiety of the metal-containing organic compound, and most preferably at least a temperature at which the rate of weight loss reaches 15% of the organic moiety of the metal-containing organic compound and not more than a temperature at which the rate of weight loss reaches 85% of the organic moiety of the metal-containing organic compound. These temperatures are exemplified as criteria for determining the decomposition starting temperature and the complete decomposition temperature.

In the present invention, the heating temperature can be appropriately set within the temperature range depending on the type of metal-containing organic compound, the type of thermoplastic resin, and the like. For example, for a metal-containing organic compound having a decomposition starting temperature of about 200° C. and a complete decomposition temperature of about 400° C., a method of maintaining the heating temperature in the range of 200° C. to 400° C. is preferred. The retention time may be appropriately changed according to the heating temperature and the like.

To ensure the dispersion of the particles while preventing the aggregation of the ultrafine particles in the presence of the thermoplastic resin, the resin composition is preferably produced at a temperature equal to or higher than the melting point of the thermoplastic resin. For example, when a thermoplastic resin composition is produced with a metal-containing organic compound having a decomposition starting temperature of about 200° C. and a complete decomposition temperature of about 400° C. and a thermoplastic resin having a melting point of about 250° C., a method of maintaining the heating temperature in the range of 250° C. to 400° C. is preferred.

The melting point of the thermoplastic resin can be measured as follows: The resin is placed in a Method A flow measurement apparatus and heated at a constant heating rate under a load of 9.8 MPa. The temperature at which the resin starts to flow from a nozzle having a diameter of 1 mm and length of 1 cm is defined as the melting point.

A heating atmosphere is not particularly limited, as long as that the thermoplastic resin is present. However, when oxidation of the particles is hoped to be avoided in synthesizing the ultrafine metal particles or when the thermoplastic resin is affected by the atmosphere, it is preferred that heating is performed under reduced pressure or the ambient atmosphere is replaced with an inert gas, according to need. Examples of the usable inert gas include nitrogen, carbon dioxide, argon, and helium. Currents of these gases may be used. Alternatively, supercritical fluids of these gases may also be used at high temperatures and pressures.

When the ultrafine metal oxide particles are synthesized, heating is preferably performed in an oxygen-containing atmosphere such as atmospheric air.

The thermoplastic resin used for the thermoplastic resin composition of the present invention is not particularly limited. It is possible to use various thermoplastic polymeric compounds with which the ultrafine particles can be mixed. The thermoplastic resin may be a synthetic resin, a naturally existing resin, or a mixture of these resins.

To suitably use the thermoplastic resin in the present invention, it is preferred to use the thermoplastic resin meeting the following requirements at a reaction temperature of not lower than the decomposition starting temperature and lower than the complete decomposition temperature of the metal-containing organic compound: (1) the thermoplastic resin is melted at the reaction temperature; (2) the thermoplastic resin does not easily undergo significant thermal decomposition and thermal degradation at the reaction temperature; and (3) the decomposition reaction of the thermoplastic resin due to the metal-containing organic compound does not easily occur at the reaction temperature.

For example, in the case where a polyester resin as the thermoplastic resin and a metal salt of a carboxylic acid as the metal-containing organic compound are used, the metal salt of the carboxylic acid facilitates an ester exchange reaction at the melting point of the polyester resin to easily cause a side reaction such as the thermal decomposition of the resin. Thus, this combination is not preferred. However, the production method of the present invention can be applied even using the unpreferred combination by appropriately combining conditions, such as removing the ambient atmosphere with an inert gas, maintaining a reduced pressure to shut off air and appropriately remove a decomposed product, and optimising the heating temperature and the heating time.

Examples of the thermoplastic resin include aromatic vinyl resins such as polystyrenes; vinyl cyanide resins such as polyacrylonitriles; chloride resins such as polyvinyl chlorides; polymethacrylic acid ester resins and polyacrylic acid ester resins, such as polymethyl methacrylates; polyolefin resins, such as polyethylenes, polypropylenes, and cyclic polyolefin resins; polyvinyl ester resins such as polyvinyl acetates; polyvinyl alcohol resins and their derivative resins; polymethacrylic resins, polyacrylic resins, and resins of the metal salts thereof; polyconjugated diene resins; polymers obtained by polymerization of maleic acid, fumaric acid, or derivatives thereof; polymers obtained by polymerization of maleimide compounds; polyester resins; polyamide resins; polycarbonate resins; polyurethane resins; polysulfone resins; polyalkylene oxide resins; cellulosic resins; polyphenylene ether resins; polyphenylene sulfide resins; polyketone resins; polyalylate resins; polyimide resins; polyamide-imide resins; polyether-imide resins; polyether-ketone resins; polyether ether ketone resins; polyvinyl ether resins; phenoxy resins; fluorocarbon resins; silicone resins; liquid crystal polymers; and random, block, or graft copolymers of these exemplified polymers. These thermoplastic resins may be used alone or in combination of two or more. In the use of a combination of two or more resins, a compatibilizer and the like may be used, according to need. These thermoplastic resins may be appropriately used in accordance with the intended use.

An apparatus for producing the resin composition of the present invention is not particularly limited. A method of melt-kneading the thermoplastic resin and the metal-containing organic compound with any one of various general kneading apparatuses is exemplified. Examples of the kneading apparatus include single-screw extruders, twin-screw extruders, rolls, Banbury mixers, and kneaders. In particular, a kneading apparatus having high shearing efficiency is preferred. The thermoplastic resin and the metal-containing organic compound may be placed all at once and melt-kneaded in the above-described kneading apparatus. Alternatively, the thermoplastic resin and the metal-containing organic compound may be melt-kneaded using a method of adding the melted thermoplastic resin with a liquid metal-containing organic compound alone or the metal-containing organic compound dissolved in a dispersion medium such as a solvent; and then removing the dispersion medium such as the solvent.

Furthermore, the metal-containing organic compound for use in the present invention may be added to the resin dissolved in a solvent to mix the metal-containing organic compound with the resin. Alternatively, a mixture of the resin and the metal-containing organic compound may be dispersed or dissolved in a solvent to mix the metal-containing organic compound with the resin.

However, to obtain a composition containing highly dispersed ultrafine particles as shown in the present invention, the composition is preferably produced by a method of melt-kneading the thermoplastic resin and the metal-containing organic compound with a melt-kneading apparatus under shearing force. A process for producing the above-described composition is not particularly limited. For example, the composition may be produced by melt-kneading the above-described components, another additive, a resin, and the like with a melt-kneading apparatus, such as a single- or twin-screw extruder. When the additives are liquid, the composition may be produced by putting them into the melt-kneading apparatus in the course of the process using a liquid feed pump or the like.

A more preferred method for producing the composition as described above includes heating the metal-containing organic compound at a temperature of not lower than the decomposition starting temperature of the metal-containing organic compound, lower than the complete decomposition temperature of the metal-containing organic compound, and higher than the melting point of the thermoplastic resin; and then exposing the resulting melted thermoplastic resin composition to a reduced pressure equal to or lower than atmospheric pressure. Reducing the pressure can appropriately remove by-products generated by thermal decomposition of the metal-containing organic compound, thus prevent the thermoplastic resin composition from being contaminated with the by-products and, in some cases, facilitate the reaction by removal of the by-products.

An apparatus used in the method for the production is not particularly limited. A melt-kneading apparatus having a decompression mechanism is preferably used. Furthermore, to prevent the aggregation of formed ultrafine particles in the resin, the melt-kneading apparatus is preferably an intermeshing extruder with twin or more screws. When the intermeshing extruder with twin or more screws is used, the extruder preferably has a structure, such as a kneading disc or a reverse flighted section, for retaining the resin between a material feed throat and a decompression vent port in a screw portion. This structure enables the continuous production of the resin composition while a periphery of the decompression vent port is maintained at a reduced pressure.

In the resin composition of the present invention, the lower limit of the content of the ultrafine particles is preferably 0.0001 parts by weight, more preferably 0.001 parts by weight, still more preferably 0.01 parts by weight, and most preferably 0.03 parts by weight relative to 100 parts by weight of the resin. The upper limit of the content is preferably 200 parts by weight, more preferably 150 parts by weight, still more preferably 100 parts by weight, and most preferably 50 parts by weight. When the content of the ultrafine particles is less than 0.0001 parts by weight, electronically-, optically-, electrically-, magnetically-, chemically-, or mechanically-specific characteristics obtained by addition of the ultrafine particles are not sufficiently achieved, in some cases. When the content exceeds 200 parts by weight, it tends to be difficult to disperse the ultrafine particles in the resin.

Furthermore, the thermoplastic resin composition of the present invention may be a reinforced material produced by combination with a reinforcing filler within the range in which the characteristics of the present invention is not impaired. That is, it is possible to further improve heat resistance, mechanical strength, and the like by incorporation of the reinforcing filler. The reinforcing filler is not particularly limited. Examples thereof include fibrous fillers, such as a glass fiber, a carbon fiber, and a potassium titanate fiber; glass beads and glass flakes; silicate compounds, such as talc, mica, kaolin, wollastonite, smectite, and diatomaceous earth; and other compounds, such as calcium carbonate, calcium sulfate, and barium sulfate. Among them, silicate compounds and fibrous fillers are preferred.

To obtain a higher-performance thermoplastic resin composition of the present invention, antioxidants, such as phenolic antioxidants and thioether antioxidants, and heat stabilizers such as phosphorus stabilizers are preferably used alone or in combination of two or more. Furthermore, according to need, well-known additives, such as lubricants, release agents, plasticizers, flame retardants, auxiliary flame retardants, antidripping agents, ultraviolet absorbers, light stabilizers, pigments, dyes, antistatic agents, conductivity-imparting agents, dispersants, compatibilizers, and antimicrobial agents, may also be used alone or in combination of two or more.

A forming process for the thermoplastic resin composition produced in the present invention is not particularly limited. Generally known forming processes, such as film forming, injection molding, blow molding, extrusion molding, vacuum forming, press forming, calendering, and foam molding, may be employed. Furthermore, the thermoplastic resin composition of the present invention can be suitably used for various applications.

### EXAMPLES

Examples will be described below to further clarify features of the present invention.

Measurement of Number-Average Particle Size of Ultrafine Particles in Resin Composition: An ultrathin section for observation with a transmission electron microscope (TEM) was prepared from an obtained resin composition using an ultramicrotome (Ultracut UCT, manufactured by Leica Microsystems GmbH). Then, the dispersion state of the ultrafine particles at a plurality of places was photographed at about ×10,000 to ×400,000 magnification with a transmission electron microscope (TEM) (JEM-1200EX, manufactured by JEOL Ltd). The particle sizes of at least 100 particles were measured using the resulting transmission electron micrographs, and the number-average particle size of the particles was calculated.

Measurement of Peak Absorption Wavelength: The light transmittance of a film having a thickness of about 80 μm was measured at a wavelength of 800 nm to 300 nm with a ultraviolet and visible spectrophotometer (UV-3150, manufactured by Shimadzu Corporation) to measure a peak absorption wavelength.

### Production Example 1

### Production of Silver Stearate as Metal-Containing Organic Compound

Commercially available sodium stearate was dissolved in deionized water by heating at 60° C. An equivalent amount of silver nitrate was separately dissolved in deionized water. The silver nitrate solution was added to the aqueous sodium stearate solution to deposit silver stearate, followed by suction filtration. After unreacted materials and by-products were removed by repeated washing with ethanol, toluene, and deionized water in that order, the resulting compound was dried in a vacuum dryer to yield a target compound.

The prepared compound was subjected to thermogravimetric analysis in a nitrogen gas atmosphere at a heating rate of 10° C./min with a thermogravimetric analyzer (TG/DTA6200, manufactured by Seiko Instruments Inc.). As a result, the decomposition starting temperature was 180° C. The decomposition peak temperature was 243° C. The complete decomposition temperature was 340° C.

### Production Example 2

### Production of Silver Oleate as Metal-Containing Organic Compound

Commercially available sodium oleate was dissolved in deionized water by heating at 60° C. An equivalent amount of silver nitrate was separately dissolved in deionized water. The silver nitrate solution was added to the aqueous sodium oleate solution to deposit silver oleate, followed by suction filtration. After unreacted materials and by-products were removed by repeated washing with ethanol, toluene, and deionized water in that order, the resulting compound was dried in a vacuum dryer to yield a target compound.

### Production Example 3

### Production of Silver Laurate as Metal-Containing Organic Compound

Commercially available lauric acid and sodium hydroxide were placed in deionized water. The mixture was heated to 60° C. to form a solution, thereby yielding sodium laurate. An equivalent amount of silver nitrate was separately dissolved in deionized water. The silver nitrate solution was added to the aqueous sodium laurate solution to deposit silver laurate, followed by suction filtration. After unreacted materials and by-products were removed by repeated washing with ethanol, toluene, and deionized water in that order, the resulting compound was dried in a vacuum dryer to yield a target compound.

### Production Example 4

### Production of Copper Oleate as Metal-Containing Organic Compound

Commercially available sodium oleate was dissolved in deionized water by heating at 60° C. An equivalent amount of copper nitrate was separately dissolved in deionized water. The copper nitrate solution was added to the aqueous sodium oleate solution to deposit copper oleate. The resulting oily copper oleate was separated with a separating funnel and washed several times with deionized water to yield a target compound.

### Production Example 5

### Production of Nickel Para-Toluate as Metal-Containing Organic Compound

Commercially available para-toluic acid was dissolved in deionized water by heating at 60° C. An equivalent amount of nickel chloride was separately dissolved in deionized water. The nickel chloride solution was added to the aqueous para-toluic acid solution to deposit nickel para-toluate, followed by suction filtration. The resulting nickel para-toluate was washed with deionized water and dried in a dryer under reduced pressure to yield a target compound.

### Production Example 6

### Production of Silver Perfluorododecanoate as Metal-Containing Organic Compound

Commercially available perfluorododecanoic acid was dissolved in hexafluorobenzene by heating at 60° C. An equivalent amount of silver nitrate was dissolved in methanol. The silver nitrate solution was added to the solution of perfluorododecanoic acid in hexafluorobenzene. The mixture was stirred for 3 hours to deposit silver perfluorododecanoate, followed by suction filtration. Unreacted materials and by-products were removed by repeated washing with hexafluorobenzene and hot chloroform in that order. The silver perfluorododecanoate was dried in a vacuum dryer to yield a target compound.

### Example 1

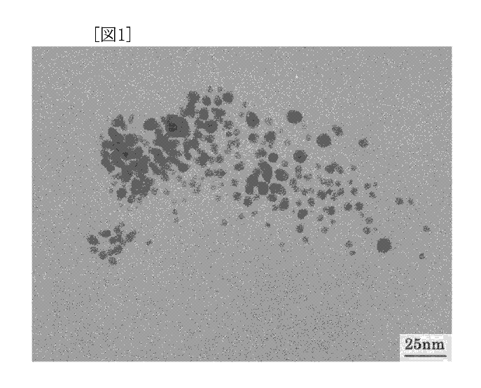

First, 500 g of G9305 (manufactured by PS Japan Corporation), which was a general-purpose polystyrene resin, 1.81 g of silver stearate as a metal-containing organic compound produced in PRODUCTION EXAMPLE 1, and 1.0 g of ADK STAB AO-60 (manufactured by Adeka Corporation), which was a phenolic stabilizer, were weighed and dry-mixed. Then, the resulting mixture was melt-kneaded with an intermeshing co-rotating twin-screw extruder KZW15-45 (manufactured by Technovel Corporation, L/D=45) having a screw diameter of 15 mm and two decompression vent ports in a screw portion under the following melt-kneading conditions: a set tip temperature of 220° C., a number of revolutions of each screw of 300 rpm, and a discharge rate of 600 g/hr. A T-die having a width of 150 mm was attached to the end of the melt-kneading apparatus. A film sample extruded from the die was taken up on a roll having a temperature of 85° C. at a rate of 100 m/hr to obtain a transparent yellow resin film sample containing ultrafine silver particles dispersed in the polystyrene resin. The resulting resin film was observed with an optical microscope. As a result, no particulate was observed. The peak absorption wavelength of the film was 418 nm. This wavelength was in close agreement with the absorption wavelength of the surface plasmon of the silver nanoparticles observed in an unaggregated state. The ultrafine particles in the resin composition had a number-average particle size of about 6 nm. FIG. 1 is an image of the ultrafine particles observed with a TEM. When the ultrafine particle-containing resin film was dissolved in toluene, no precipitate was observed. A yellowish transparent state was observed. That is, it was confirmed that the resulting ultrafine particles were stably dispersed in the organic solvent without aggregation. Furthermore, deionized water was added to the toluene solution, and then the mixture was stirred and left standing. The yellowish silver nanoparticles were present in the toluene solvent. Therefore, it was confirmed that an organic component was bonded to the surface of each silver nanoparticles.

### Example 2

An ultrafine silver particle-containing resin composition film was prepared as in EXAMPLE 1, except that the amount of silver stearate was 18.1 g. The ultrafine particles in the resin composition had a number-average particle size of about 15 nm. Similarly, an organic component was bonded to the surface of each particle.

### Example 3

An ultrafine silver particle-containing resin composition film was prepared as in EXAMPLE 1, except that ACRYPET VH5-000 (manufactured by Mitsubishi Rayon Co., Ltd.), which was a polymethyl methacrylate resin, was used in place of the general-purpose polystyrene resin. The ultrafine particles in the resin composition had a number-average particle size of about 7 nm. An organic component was bonded to the surface of each particle.

### Example 4

An ultrafine silver particle-containing resin composition film was prepared as in EXAMPLE 1, except that 1.80 g of silver oleate produced in PRODUCTION EXAMPLE 2 was used in place of 1.81 g of silver stearate. The ultrafine particles in the resin composition had a number-average particle size of about 8 nm. An organic component was bonded to the surface of each particle.

### Example 5

An ultrafine silver particle-containing resin composition film was prepared as in EXAMPLE 1, except that 1.42 g of silver laurate produced in PRODUCTION EXAMPLE 3 was used in place of 1.81 g of silver stearate, and the tip temperature of the twin-screw extruder was set at 200° C. The ultrafine particles in the resin composition had a number-average particle size of about 6 nm. An organic component was bonded to the surface of each particle.

### Example 6

A resin composition film containing ultrafine copper particles and ultrafine copper oxide particles was prepared as in EXAMPLE 1, except that 5.51 g of copper 2-ethylhexanoate (reagent, manufactured by Sigma-Aldrich Japan KK) was used in place of 1.81 g of silver stearate, and the tip temperature of the twin-screw extruder was set at 230° C. The ultrafine particles in the resin composition had a number-average particle size of about 10 nm. An organic component was bonded to the surface of each particle.

### Example 7

An ultrafine zinc oxide particle-containing resin composition film was prepared as in EXAMPLE 1, except that 4.85 g of zinc stearate (reagent, manufactured by Wako Pure Chemical Industries, Ltd.) was used in place of 1.81 g of silver stearate, the tip temperature of the twin-screw extruder was set at 230° C., and the discharge rate was 300 g/hr. The ultrafine particles in the resin composition had a number-average particle size of about 6 nm. An organic component was bonded to the surface of each particle.

### Example 8

First, 500 g of XAREC S100 (manufactured by Idemitsu petrochemicals Co., Ltd.), which was a syndiotactic polystyrene resin, 4.93 g of copper oleate produced in PRODUCTION EXAMPLE 4 as a metal-containing organic compound, and 1.0 g of ADK STAB AO-60 (manufactured by Adeka Corporation), which was a phenolic stabilizer, were weighed and blended. Then, the resulting mixture was melt-kneaded with an intermeshing co-rotating twin-screw extruder KZW15-45 (manufactured by Technovel Corporation, L/D=45) having a screw diameter of 15 mm and two decompression vent ports in a screw portion under the following melt-kneading conditions: a set tip temperature of 300° C., a number of revolutions of each screw of 300 rpm, and a discharge rate of 500 g/hr. A T-die having a width of 150 mm was attached to the end of the melt-kneading apparatus. A film sample extruded from the die was taken up on a roll having a temperature of 110° C. at a rate of 100 m/hr to obtain a resin film containing ultrafine copper particles dispersed in the syndiotactic polystyrene resin. The ultrafine particles in the resin composition had a number-average particle size of about 10 nm. An organic component was bonded to the surface of each particle.

### Example 9

An ultrafine nickel oxide particle-containing resin composition film was prepared as in EXAMPLE 8, except that 1.13 g of nickel para-toluate produced in PRODUCTION EXAMPLE 5 was used in place of 4.93 g of copper oleate. The ultrafine particles in the resin composition had a number-average particle size of about 11 nm. An organic component was bonded to the surface of each particle.

### Example 10

An ultrafine silver particle-containing resin composition film was prepared as in EXAMPLE 8, except that 3.34 g of silver perfluorododecanoate produced in PRODUCTION EXAMPLE 6 was used in place of 4.93 g of copper oleate. The ultrafine particles in the resin composition had a number-average particle size of about 12 nm. An organic component was bonded to the surface of each particle.

### Example 11

First, 500 g of NUCREL (manufactured by Du Pont-Mitsui Polychemicals), which was an acid-modified polyethylene resin, 1.71 g of commercially available niobium ethoxide as a metal-containing organic compound, and 1.0 g of ADK STAB AO-60 (manufactured by Adeka Corporation), which was a phenolic stabilizer, were weighed and blended. Then, the resulting mixture was melt-kneaded with an intermeshing co-rotating twin-screw extruder KZW15-45 (manufactured by Technovel Corporation, L/D=45) having a screw diameter of 15 mm and two decompression vent ports in a screw portion under the following melt-kneading conditions: a set tip temperature of 150° C., a number of revolutions of each screw of 300 rpm, and a discharge rate of 500 g/hr. A T-die having a width of 150 mm was attached to the end of the melt-kneading apparatus. A film sample extruded from the die was taken up on a roll having a temperature of 10° C. at a rate of 100 m/hr to obtain a resin film containing ultrafine niobium oxide particles and ultrafine niobium particles dispersed in the polyethylene resin. The ultrafine particles in the resin composition had a number-average particle size of about 20 nm. An organic component was bonded to the surface of each particle.

### Example 12

A resin composition film containing ultrafine copper particles and ultrafine copper oxide particles was prepared as in EXAMPLE 11, except that 2.06 g of commercially available bis(acetylacetonato)copper(II) was used as the metal-containing organic compound. The ultrafine particles in the resin composition had a number-average particle size of about 45 nm. An organic component was bonded to the surface of each particle.

### Comparative Example 1

First, 100 g of silver stearate produced in PRODUCTION EXAMPLE 1 was weighed, placed in a 500-mL recovery flask, and heated under a nitrogen flow at a flow rate of 100 mL/min. The heating temperature was set at 220° C. This temperature was maintained for 4 hours. Then, purification was performed by solvent extraction to obtain an ultrafine silver powder having particle size of about 5 nm. Next, the silver powder was weighed such that the silver component was 0.5 g and mixed with 500 g of G9305 (manufactured by PS Japan Corporation), which was a general-purpose polystyrene resin. The mixture was dry-mixed with 1.0 g of ADK STAB AO-60 (manufactured by Adeka Corporation), which was a phenolic stabilizer. Then, the resulting mixture was melt-kneaded with an intermeshing co-rotating twin-screw extruder KZW15-45 (manufactured by Technovel Corporation, L/D=45) having a screw diameter of 15 mm and two decompression vent ports in a screw portion under the following melt-kneading conditions: a set tip temperature of 250° C., a number of revolutions of each screw of 300 rpm, and a discharge rate of 600 g/hr. A T-die having a width of 150 mm was attached to the end of the melt-kneading apparatus. A film sample extruded from the die was taken up on a roll having a temperature of 85° C. at a rate of 100 m/hr to obtain a resin film containing silver particles dispersed in the polystyrene resin. The resulting resin film was observed with an optical microscope. As a result, many particulates were observed. This film exhibited a substantially constant absorption across the entire visible wavelength region. No absorption peak corresponding to the absorption wavelength of the surface plasmon of the silver nanoparticles was observed. The silver particles in the resin composition were aggregated with no definite form. A small number of particles could be observed with a TEM. However, it was found that the number-average particle size of the silver particles was about 120 nm.

### Comparative Example 2

NPS-J (manufactured by Harima Chemicals, Inc., number-average particle size: 3 to 7 nm), which was a commercially available paste containing silver nanoparticles dispersed in tetradecane, was weighed such that the silver component was 0.5 g and mixed with 500 g of G9305 (manufactured by PS Japan Corporation), which was a general-purpose polystyrene resin. The mixture was dry-mixed with 1.0 g of ADK STAB AO-60 (manufactured by Adeka Corporation), which was a phenolic stabilizer. Then, the resulting mixture was melt-kneaded with an intermeshing co-rotating twin-screw extruder KZW15-45 (manufactured by Technovel Corporation, L/D=45) having a screw diameter of 15 mm and two decompression vent ports in a screw portion under the following melt-kneading conditions: a set tip temperature of 220° C., a number of revolutions of each screw of 300 rpm, and a discharge rate of 600 g/hr. A T-die having a width of 150 mm was attached to the end of the melt-kneading apparatus. A film sample extruded from the die was taken up on a roll having a temperature of 85° C. at a rate of 100 m/hr to obtain a resin film containing silver particles dispersed in the polystyrene resin. The resulting resin film was observed with an optical microscope. As a result, many particulates were observed. This film exhibited a substantially constant absorption across the entire visible wavelength region. No absorption peak corresponding to the absorption wavelength of the surface plasmon of the silver nanoparticles was observed. The silver particles in the resin composition were aggregated with no definite form. A small number of the particles could be observed with a TEM. However, it was found that the number-average particle size of the silver particles was about 100 nm.

### INDUSTRIAL APPLICABILITY

According to the present invention, by uniformly dispersing ultrafine particles in a resin without aggregation, the ultrafine particles can be held in a resin composition while various excellent characteristics intrinsically possessed by the ultrafine particles are maintained. Thus, the present invention is also useful for protection of the ultrafine particles. Furthermore, by forming an article, a film, or the like simultaneously with the production of the inventive resin composition, it is possible to desirably mass-produce a resin formed article maintaining the dispersion state of the ultrafine particles. Thus, the ultrafine particles, which have been difficult to handle in the past, can be applied to various fields. Therefore, it is expected that the present invention contribute significantly to bringing products in nanotechnology fields into active use. Furthermore, the present invention is significantly useful for industry.

1. A method for producing a thermoplastic resin composition containing ultrafine particles, the method comprising mixing a metal-containing organic compound with a thermoplastic resin; and then heating the resulting mixture at a temperature of at least the decomposition starting temperature and lower than the complete decomposition temperature of the metal-containing organic compound to produce a composition containing ultrafine metal particles and/or ultrafine metal oxide particles having a number-average particle size of 0.1 to 80 nm dispersed in the thermoplastic resin.

2. The method for producing the thermoplastic resin composition containing ultrafine particles according to claim 1, wherein the ultrafine metal particles and/or the ultrafine metal oxide particles having a number-average particle size of 0.1 to 80 nm dispersed in the thermoplastic resin is composed of a metal component or a metal oxide component, and an organic component is bonded to the surface of the particle.

3. The method for producing the thermoplastic resin composition containing ultrafine particles according to claim 1, wherein the ultrafine particles having a number-average particle size of 0.1 to 80 nm dispersed in the thermoplastic resin are synthesized in the thermoplastic resin.

4. The method for producing the thermoplastic resin composition containing ultrafine particles according to claim 1, wherein the heating temperature is not lower than the decomposition starting temperature of the metal-containing organic compound, lower than the complete decomposition temperature of the metal-containing organic compound, and higher than the melting point of the thermoplastic resin.

5. The method for producing the thermoplastic resin composition containing ultrafine particles according to claim 1, wherein the metal component is at least one element selected from Cu, Ag, Au, Zn, Cd, Ga, In, Si, Ge, Ti, Sn, Pd, Fe, Co, Ni, Ru, Rh, Os, Ir, Pt, V, Cr, Mn, Y, Zr, Nb, Mo, Ca, Sr, Ba, Sb, and Bi.

6. The method for producing the thermoplastic resin composition containing ultrafine particles according to claim 1, further comprising exposing the resulting melted thermoplastic resin composition to a reduced pressure equal to or lower than atmospheric pressure after the metal-containing organic compound is heated at a temperature of not lower than the decomposition starting temperature of the metal-containing organic compound, lower than the complete decomposition temperature of the metal-containing organic compound, and higher than the melting point of the thermoplastic resin.

7. The method for producing the thermoplastic resin composition containing ultrafine particles according to claim 1, the method further comprising kneading the melted thermoplastic resin and the metal-containing organic compound to disperse ultrafine metal particles and/or ultrafine metal oxide particles in the thermoplastic resin, wherein the central portion of the particle is composed of a metal component or a metal oxide component, an organic component is bonded to the surface of the particle, and the particles dispersed have a number-average particle size of 1 to 60 nm.
